(19) United States
(12) Patent Application Publication
(10) Pub. No.: US 2017/0372143 A1
(43) Pub. Date: Dec. 28, 2017

(54) APPARATUS, SYSTEMS AND METHODS FOR ENHANCED VISUAL INSPECTION OF VEHICLE INTERIORS

(71) Applicant: GATEKEEPER, INC., Sterling, VA (US)

(72) Inventors: Richard BARCUS, Reston, VA (US); Edward BINDON, Fairfax, VA (US); Tony VU, Lancaster, PA (US)

(21) Appl. No.: 15/524,162

(22) PCT Filed: May 13, 2016
(86) PCT No.: PCT/US2016/032279

§ 371 Date: May 3, 2017

Related U.S. Application Data
(60) Provisional application No. 62/161,568, filed on May 14, 2015.

(51) Int. Cl. G06K 9/00; G06K 9/20; G06F 17/30; H04N 7/18; G06K 9/62; H04N 5/92

(52) U.S. Cl. CPC G06K 9/00771; G06F 17/30256; G06F 17/3028; H04N 7/18; G06K 9/00832; G06K 9/2027; G06F 17/30253; G06K 9/00288; G06K 2209/15; G06K 2209/23; G06K 2209/27; H04N 5/9201; G06K 9/6215

(57) ABSTRACT

Devices, systems, and methods enhance the inspection of internal areas and occupants of vehicles, and can employ one or more high-resolution cameras, one or more auxiliary illumination devices and a related computer system. According to various embodiments, an auxiliary illumination device can be synchronized to one or more cameras, and configured to supply auxiliary illumination to facilitate capture of accurate and usable images. Advanced image processing solutions assist with identifying individuals inside a vehicle, removing light glare and undesired reflections from a window surface, and capturing an image through a tinted window, among other things. Further, embodiments can compare a captured image to an authenticated image from a database, so as to confirm the identity of a vehicle occupant.

### TECHNICAL FIELD

The present disclosure relates to visual inspection systems, and more particularly to enhanced visual inspection devices, systems and methods for vehicle interiors.

### BACKGROUND

Governments, businesses and even individuals are seeking more effective and efficient methods for increasing the security at vehicle entry points to physical locations, particularly for secure facilities. Various technology solutions can identify a given vehicle at an entry point, and searches can be undertaken, both externally and internally, to identify any potential threats. To a limited degree, some technology solutions can identify drivers and passengers in a vehicle at an entry point, but such solutions require the occupant(s) such as the driver and/or passenger to stop, open the window and present some form of identification document, such as a photo ID or RFID Proximity Card, for example, or some form of biometric information that may be scanned by facial or retinal cameras, for example. This vehicle occupant identification process is time consuming and often not practical to handle high traffic volume. Further, the extra identification time may also not be appropriate for vehicles carrying special privilege occupants that are not willing to undergo routine security procedures.

In addition, efforts to inspect vehicle interiors through a barrier such as a window, or while a vehicle is moving, face constraints. For example, significant variability exists in ambient and vehicle cabin lighting conditions, weather conditions, window reflectivity, and window tint. These variations raise numerous challenges to conventional imagery-based identification systems. For example, light reflection from a window surface can render an image nearly useless, and heavy glass tinting can make identifying an individual inside a vehicle next to impossible.

Solutions are needed that allow for a rapid and minimally invasive identification of vehicle occupants and contents. Further, solutions are needed that overcome the challenges associated with variable lighting, weather conditions, window tint, and light reflection.

### SUMMARY

The present disclosure relates to devices, systems, and methods for enhancing the inspection of vehicles, and in particular the visual inspection of occupants and contents inside vehicles. Embodiments can include one or more high resolution cameras, and one or more auxiliary illumination devices. According to various embodiments, an auxiliary illumination device can be synchronized to one or more cameras, and configured to supply auxiliary illumination. For example, auxiliary illumination may be supplied in approximately the same direction as an image capture, at about the same moment as an image capture, and/or at about a similar light frequency as the image capture.

Embodiments can further include a computer system or camera with embedded processing unit configured to operate advanced image processing functions, routines, algorithms and processes. An advanced image processing device and methodology according to the present disclosure can include and operate processes for identifying individuals inside a vehicle, comparing currently captured images of individuals to stored images of individuals, removing light glare and undesired reflections from a window surface, and capturing an image through a tinted window, among other things. For example, an algorithm can compare different images of the same target vehicle/occupant and use the differences between the images to enhance the image and/or reduce or eliminate unwanted visual artifacts. Further, an algorithm can compare a captured image to an authenticated image from a database, so as to confirm the identity of a vehicle occupant, for example. Embodiments can be deployed in various locations, such as facility ingress and egress locations, inside large complexes and facilities, border crossings, and at secure parking facilities, among other locations.

### BRIEF DESCRIPTION OF THE DRAWINGS

FIG. 1 is a schematic diagram illustrating an entry control system according to one embodiment of the present disclosure.

FIG. 2 is a schematic diagram illustrating an entry control system according to another embodiment of the present disclosure.

FIGS. 3 through 5 are example screen displays associated with a monitor interface incorporated in one embodiment of the present disclosure.

FIG. 6 is an exemplary schematic layout of an entry control system in accordance with one aspect of the present disclosure.

### MODES FOR CARRYING OUT THE INVENTION

The following description is of the best currently contemplated mode of carrying out exemplary embodiments of the invention. The description is not to be taken in a limiting sense, and is made merely for the purpose of illustrating the general principles of the invention.

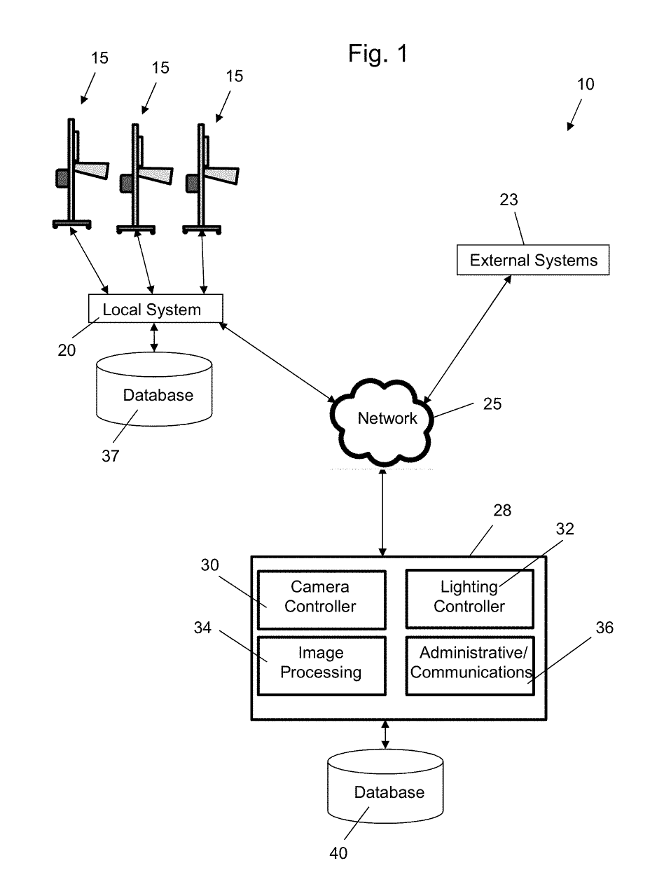

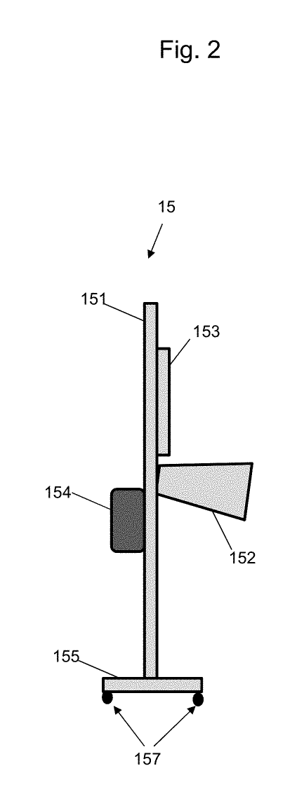

As shown in FIGS. 1 and 2, the present invention can be implemented as part of an entry control system 10, including one or more entry control devices (shown generally at 15) and a remote central system 28 including a controller accessible via a network 25, wherein system 28 can access database 40. In various embodiments, a single device 15 or group of devices 15 can include an integrated central controller as part of a local computing system 20, including a controller which can access a local database 37. The database(s) 37 and/or 40 can be used to store and update reference images and data for people and all types of vehicles. For people, reference images can be images previously obtained using the systems, devices and methods of the present disclosure, or obtained through online searches and social engineering searches, for example. In the instance of online and social engineering searches, images can be obtained via external systems 23 such as web sites and online services. For vehicles, reference images can be “stock” images of vehicles from various perspectives, including undercarriage images, made available by vehicle manufacturers, dealers or service providers, for example. Vehicle undercarriage inspection systems can be obtained, for example, through Gatekeeper, Inc. of Sterling, Va., USA, and such technology is described, for example, in U.S. Pat. No. 7,349,007, U.S. Pat. No. 8,305,442, U.S. Pat. No. 8,358,343, and U.S. Pat. No. 8,817,098, the disclosures of which are incorporated herein by reference in their entireties. Alternatively, reference images can be images created using the systems, devices and methods of the present disclosure. It will be appreciated that the effectiveness of embodiments of the present invention can be increased when using reference images created using the present disclosure, due to the increased accuracy and comprehensive detail available using the present disclosure.

As shown in FIG. 2, device 15 can include a spine 151, camera 152, illumination device 153, local computing device 154 and base 155, wherein the base 155 can be mounted on rollers, wheels or similar devices 157 that facilitate portability. In various embodiments, camera 152, illumination device 153, and computing device 154 are suitably mounted at appropriate heights and accessibility for the illumination device 153 to appropriately illuminate a field of view, and for the camera 152 to appropriately capture images in the field of view to carry out the functions described herein. Alternatively, the device 15 can be provided without a spine and base, wherein the device and one or more of its components are mounted to fixed or mobile structures at or near the deployment area for the device. The local computing device 154 can comprise the local system 20 and database 37 of FIG. 1, in accordance with various embodiments of the present disclosure.

Whether employing a local system 20 or remote central system 28, various sub-components of the system 20 or 28 provide for operation of the device 15. For instance, the camera controller 30 in FIG. 1 is operable to control the camera (e.g., 152) and settings being used at a given deployment. The lighting controller 32 operates to control illumination device (e.g., 153), including, for example, adapting for daytime lighting conditions, nighttime lighting conditions, weather-related conditions, and anticipated vehicle type and/or tint type conditions, for example. The image processing component 34 operates to process images of a driver, occupant and/or contents of a vehicle as disclosed herein. The administrative/communications component 36 permits administrative users to add, change and delete authorized users, add, change and delete deployed and/or deployable equipment, establish communication protocols, communicate with vehicle occupants via a microphone or hands-free communication device in communication with a speaker on or near device 15, enable local processing functionality at local systems 20 and/or 154, and even make and adjust settings and/or setting parameters for the device 15 and its components, including camera 152, lighting device 153 and image processing device 154, for example. Component 36 also permits communications with devices 15 directly, indirectly (such as through network 25 and local system 20) and with external computing systems 23. For example, the system 10 may need to report information about specific known criminals to external systems 23 such as law enforcement or military personnel. Alternatively, the system 10 can employ external systems 23 to gather additional details such as additional images of vehicles or individuals in order to operate in accordance with the principles and objectives described herein. While FIG. 1 illustrates components 30, 32, 34 and 36 as part of remote system 28, it will be appreciated that local system 20 or 154 can also include a respective camera controller component, lighting controller component, image processing component and administrative/communications component. For example, device 15 can include a computer processing component, which can be embedded in the camera 152 or provided as part of local device 154, which produces a digital image that can be transmitted by public or private network to a display device, such as a local computer display, or a display associated with a remote personal computer, laptop, tablet or personal communications device, for example. At such time, the image can be viewed manually or further processed as described herein. Such further processing can include a facial image processing application, for example.

In various embodiments of the present invention, local system 20 can comprise local computing device 154 having at least one processor, memory and programming, along with a display interface. In various embodiments, local computing device can comprise, for example, an aluminum casing with an opening at the front to expose a touch screen interface, and an opening at the back to expose small plugs for network cabling, power, server connection, and auxiliary device connection, for example. The screen configuration addresses a number of issues relevant to the operation of the invention. For example, the touch screen interface is intuitive (i.e., one can see it, touch it), it is readable in daylight, and it allows operators to keep gloves on in hot and cold conditions.

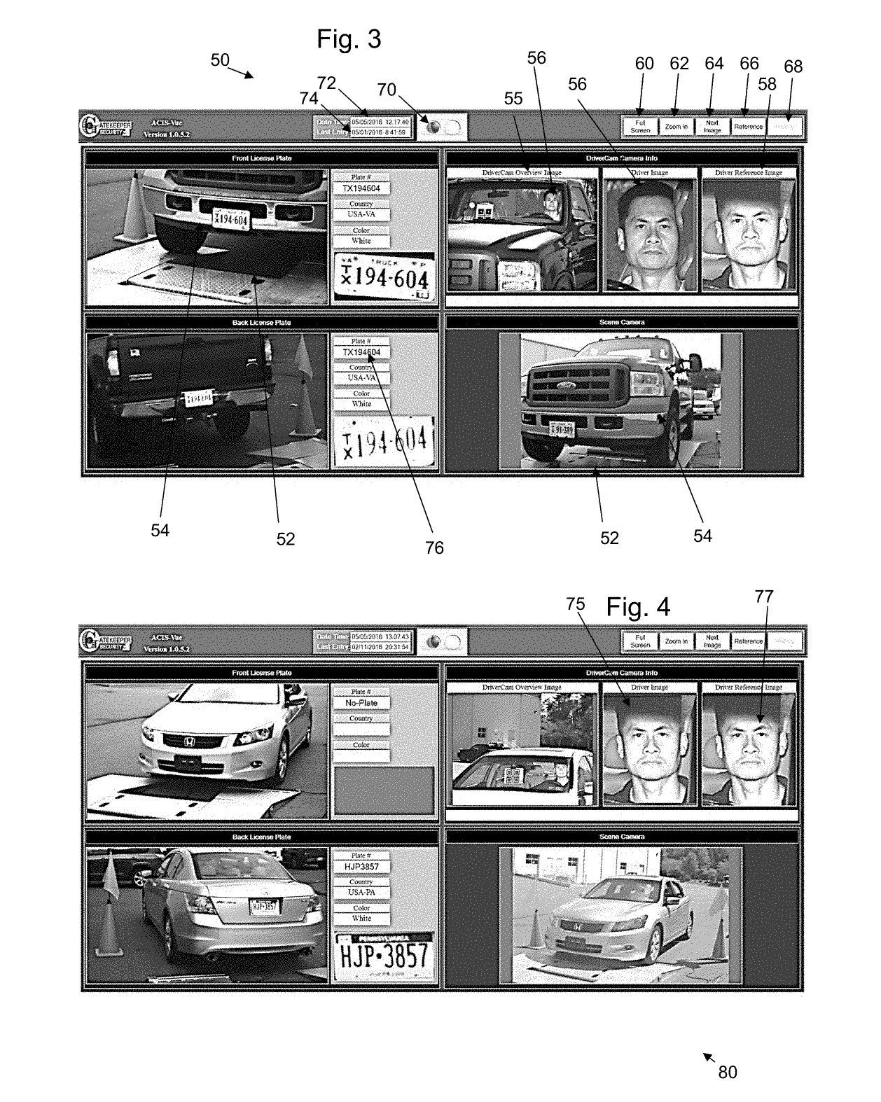

FIGS. 3 through 5 show sample screen images 50, 80 and 110 of what can appear on a display interface during operation according to the present disclosure. It will be appreciated that display interfaces can be provided locally with the device 15 (e.g., as part of device 154), and can also be provided remotely, for example, as part of an external system 23 comprising a computing device accessing images via administrative/communications component 36. Such a computing device can be of various form factors, including desktop computers, smartphone devices and devices of other sizes. As shown in FIG. 3, a portion of the interface 50 can display one or more above ground images 52 of an oncoming vehicle 54. Another portion of the interface can show an image 55 showing the interior of the oncoming vehicle 54, with one or more current images 56 of a driver or other occupant of the vehicle. In various embodiments, the two images 55, 56 appear on screen at the same time. Another portion of the interface can show a previously stored reference image 58 for comparing with image 56. Various interface buttons are shown which allow the user to show a full screen image 60, zoom 62, toggle the view between the previous and the next image 64 in a series of images, show one or more reference images 66 and show historical information 68, for example. Additionally, the user can conduct file operations such as saving the screen image, noting the date/time as at 72, noting the last system entry 74 for the person in the image 56 and noting the vehicle license plate information as at 76. The user can also view and/or control one or more traffic lights associated with the system of the present invention as described in more detail below, using input element 70, for example.

The front view display 52 of the vehicle 54 can be used to read license plates and other externally identifiable indicia, which may then be entered into the system, such as through a pop-up soft key pad on the screen, for example. The screen functions allow for full screen views of the current image and the ability to cycle from among many images of the front of the vehicle. In various embodiments, the present invention can use RFID, license plate number readers, an optically scannable barcode label and other electronic forms of identification, any of which can be called a vehicle identifier, to link vehicle images and occupants directly to a specific vehicle. In this way, the present invention can recall the vehicle details, and past occupant details, at later times, such as when the vehicle is re-identified by the system.

Embodiments thus provide an entry control system that comprises at least one camera device, at least one illumination device, and at least one controller operable to execute image processing so as to identify individuals within a vehicle. The system can access a database, such as database 37 and/or 40, which holds vehicle and individual details, including images, which can be categorized by at least one identifier, such as, for example, the vehicle make, model, year, license plate, license number, vehicle identification number (VIN), RFID tag, an optically scannable barcode label and/or vehicle owner information associated with a vehicle in which the occupant was identified. The computer can further include programming for comparing field image data obtained against the images in the database.

The present invention further retains both reference and archived images on either a local or central database and can access the images through a network configuration. Vehicles returning over the system at any point within the network can be compared automatically to their previous image (for example, by identifying the vehicle through a vehicle identifier such as a license plate number or RFID tag) or to a same or similar vehicle make and model image through the reference database. In various embodiments, the reference database comprises, in part, vehicle makes and models. In various embodiments, the vehicle image history can also be displayed by invoking the “history” button, at which time a calendar will be displayed, inviting the operator to pick a date to review images that are registered by date and time stamp. A search feature can further be activated through the interface screen, whereby a particular vehicle number plate can be entered and the associated vehicle's history can be displayed on the user interface, listing the date and time of all visits by that vehicle to that particular scanner or entry control point, and any images of vehicle occupants that have been historically collected. In a networked environment, the system can also show the date and time that the vehicle entered other control points within a control point network.

Numerous benefits are enjoyed that are not feasible through conventional photographic systems. For instance, embodiments may provide high quality images in any lighting and in any weather condition. Embodiments may perform image capture with minimal interference with a driver's vision. In various embodiments, the system can be configured to identify the number of vehicle occupants. Individual identification performance capabilities can include confirming a captured image, comparing a captured image with a previously obtained authentic image, and automated captured image confirmation, for example, via one or more image processing algorithms or protocols.

Embodiments of the system can include one or more occupant cameras and one or more auxiliary illumination devices. In some embodiments, an auxiliary illumination device can be associated with a single occupant camera. For example, operation of an occupant camera can be synchronized with operation of an auxiliary illumination device. A synchronized occupant camera and auxiliary illumination device can be configured to illuminate a target and capture an image according to a predetermined timing algorithm, in various embodiments of the present invention. In some embodiments, more than one occupant camera can be synchronized with an auxiliary illuminating device. For example, the relative layout of a vehicle approaching an image capture point, relative to other structures and objects, as well as to the mounting location(s) of a driver camera and an auxiliary illuminating device, as well as particular identification protocols in effect, may necessitate more than one camera viewpoint. In some embodiments, an occupant camera can be synchronized with more than one auxiliary illuminating device. For example, the relative layout of a vehicle approaching an image capture point, relative to other structures and objects, as well as to the mounting location(s) of an occupant camera and an auxiliary illuminating device, as well as particular identification protocols in effect, may necessitate more than one auxiliary illumination angle.

In a demonstrative embodiment, a camera synchronized with an auxiliary illumination device, such as an LED strobe, for example, can be configured using the camera component 30 to capture an image as a single frame. The exposure time of the camera can be set to a short duration via component 30, such as a few hundred micro-seconds, and for example, about 325 micro-seconds. Shorter durations reduce the adverse impact of ambient light, such as glare, on the image capture. In various embodiments, the synchronized LED strobe can be configured to trigger upon a signal for the camera to capture an image, and may emit auxiliary illumination for a few hundred micro-seconds, and for example, about 300 micro-seconds, using lighting component 32. In some embodiments, the camera exposure time may be slightly longer than the duration of the auxiliary illumination, such as about a few micro-seconds. The signal to capture an image can be provided manually, such as by an operator of local 20, 154 or remote 28 controller, or automatically, such as by a sensor deployed at the entry control point in communication with the local 20, 154 and/or remote 28 controller. Such a sensor can be, for example, a proximity sensor capable of determining the distance of an oncoming vehicle from the device 15, or a motion sensor capable of detecting motion of an oncoming vehicle past a specific point. Appropriate setup and calibration protocols can be employed to ensure that the sensors operate accurately and timely so as to ensure optimal or near-optimal image capture.

In a demonstrative embodiment, a camera synchronized with an auxiliary illumination device, such as an LED strobe, for example, can include a light filter to reduce the wavelengths of light captured. For example, a camera can include a band pass filter or other filter that allows light in a narrow portion of the visible spectrum to pass through the filter, such as about 625 nm, in the red color range. The auxiliary illumination device can also be configured to emit light in the same or similar wavelengths. Light frequency matching in this manner reduces the adverse impact of ambient light on the image capture.

An auxiliary illumination device, such as an LED strobe, for example, can be configured to emit a substantial intensity of light. The substantial intensity of light may be sufficient to penetrate most window tints, and provide sufficient light for the image capture to clearly identify objects in the interior of a vehicle having a tinted window.

In various embodiments, local system 20, 154 or remote central system 28 can be used to operate one or more components and features as described elsewhere herein. For instance, camera controller component 30 can be employed to trigger an image capture and otherwise operate an occupant camera (e.g., 152), and lighting controller component 32 can be employed to control auxiliary illuminating device (e.g., 153). Further, image processing component 34 can be employed to compare a captured image with an authenticated and/or previously stored image. It should be appreciated that a computer system such as system 20, 154 or remote central system 28 can be configured to operate one or more user interfaces to operate one or more aspects of the systems. Further, the controller can be configured to perform numerous algorithms for operating one or more aspects of the system, in addition to image capture and comparison algorithms, for instance. In some embodiments, a computer system may be integrated with a camera and/or an auxiliary illumination device.

As shown in FIG. 1, embodiments can be integrated with a computer network 25. For example, some embodiments can be connected to a network 25, and exchange information with other systems. Information can include captured images, authenticated images from a database and additional information to confirm an identity, for example. Embodiments can be provided with various power supply sources. In some embodiments, components can be provided with one or more dedicated power supply sources. For example, a camera can have an onboard battery, and an auxiliary illumination device may draw power from a capacitor bank. Some embodiments of the device 15 and/or system 20 can receive power from local power sources and/or networks, such as, for example, a distributed low voltage power cable. Some embodiments can be configured for Power over Ethernet, and receive power through Ethernet cabling.

In some embodiments of a system for enhanced visual inspection, one or more physical components can be configured for equipment ratings at IP65 or higher. As is known in the art, an IP (ingress protection) rating of 65 generally means that the component is completely protected from dust, and that the component is protected against water ingress from wind driven rain or spray. Some embodiments can include more than one camera, and other embodiments can be configured to provide more than one camera mounting position and configuration.

Embodiments can be configured for one or more mounting options, including self-mounting, structure-mounting, fence-mounting, and the like. For example, some embodiments can be configured for mounting on an existing structure, such as a standing pole, fence, facility wall, and the like. Some embodiments can be configured for overhead mounting on an existing structure, such as a rooftop application. In some embodiments, components can be configured to move, such as through panning, tilting and zooming. For example, a camera and an LED light array can be mounted with one or more degrees of freedom. Some embodiments can allow manual movement of one or more components, and in some embodiments, movement can be through electro-mechanical elements. Movement of a component can be controlled from a control station in some embodiments. It should be appreciated that numerous mounting options and movement options can be provided without departing from the principles disclosed herein.

One exemplary embodiment includes a high resolution Gigabit Ethernet (GigE) area scan camera (e.g., 152), a high-powered LED strobe light (e.g., 153), and a computer system (e.g., 154) configured for advanced image processing via component, such as component 34. The area scan camera can transfer data at rates up to around 1,000 Mb/s, and can be configured for daytime and nighttime operation. The LED strobe light can be synchronized with the area scan camera to provide auxiliary illumination. For example, auxiliary illumination can be provided in generally the same direction as the camera image capture, at generally the same moment as the image capture, and/or in similar light frequencies. The computer system and/or the camera's embedded computing unit can be configured to run one or more algorithms to detect and highlight individuals inside a vehicle, and/or reduce or remove the impact of ambient light glares.

In some embodiments, device 15 includes a camera and an auxiliary illumination device in a common housing, as shown in FIG. 2. Those components can be connected to a computer system (e.g., 20, 154 or 28) through cabling or wireless connections. Power can be received from an external power supply source, and some embodiments may include one or more onboard power supplies.

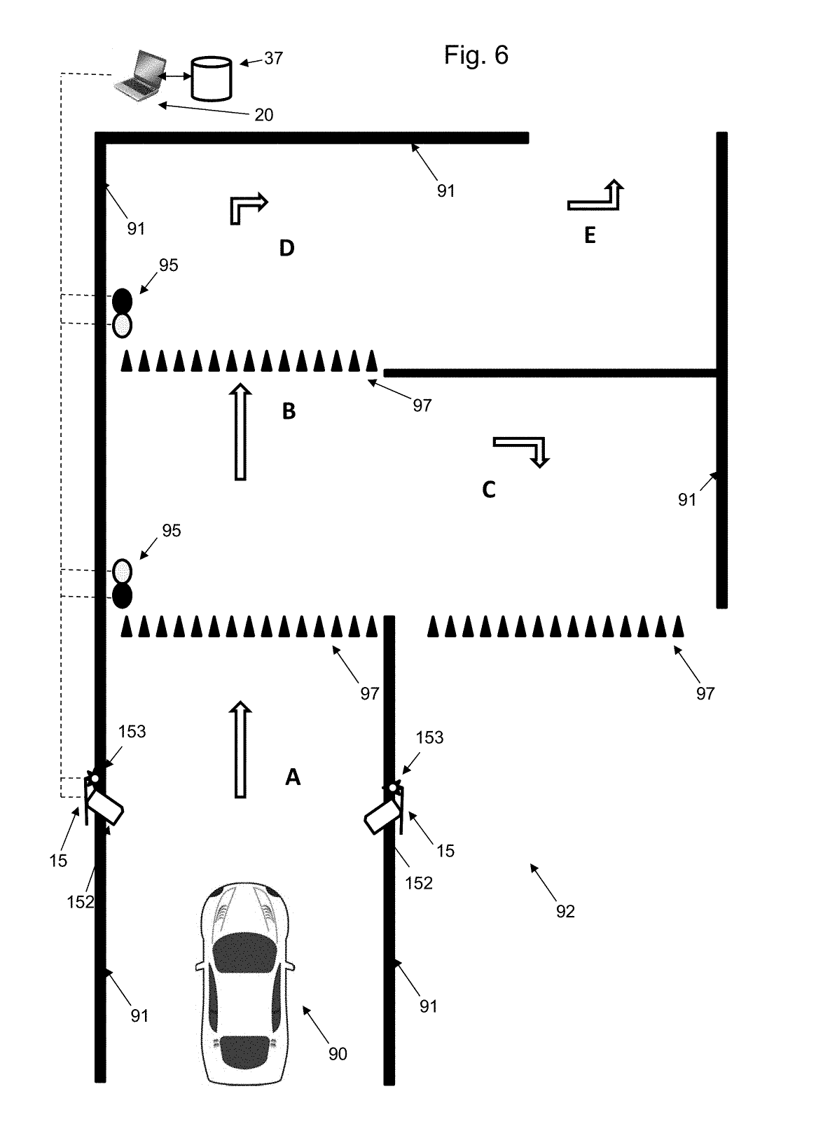

In some embodiments, a system can include one or more cameras, and one or more auxiliary illumination devices, in a common area. The camera(s) and auxiliary illumination device(s) can be configured for viewing an approaching vehicle from one or more viewpoints (e.g., direction, height, angle, etc.). For example, a facility gateway 92 can include multiple devices 15 as shown in FIG. 6, distributed on opposite sides of the gateway 92. In this example, multiple images of an approaching vehicle 90 can be captured for analysis. Captured images can be transmitted to one or more computer systems 20 configured to operate one or more identification protocols, wherein the computer system(s) 20 can access database 37, for example. In one embodiment, communications from the camera can be communicated to system 20 either by CATSE/CAT6 (Ethernet) cabling, or by ruggedized fiber optics cable ((multi-mode or single mode), for example. Some embodiments can further include an under vehicle inspection system, such as referenced above. For instance, images and other scans of the underside of a vehicle can be captured for analysis. The analysis may be conducted during the visual inspection. Some embodiments can include multiple data storage options, such as, for example, local or remote database servers, single or redundant servers and/or PSIM integration.

In some embodiments, a method for visually inspecting a vehicle includes capturing one or more high-resolution images of vehicle occupants. An auxiliary illumination device provides synchronized light, to improve clarity of the captured image(s). The captured image(s) may be displayed to access control personnel, such as at an operator terminal in communication with the camera. Access control personnel can view the displayed image(s) to see inside the vehicle, for example, to confirm the number of occupants and identify one or more occupants, for example. In this manner, access control personnel can visually inspect the interior of a vehicle in a range of lighting and viewing conditions.

In various embodiments, a computer system and/or the camera's embedded computing unit can be included and configured to perform advanced image processing. Advanced image processing can include various color and contrast adjustments to improve image clarity. Appropriate color and contrast adjustments can depend on the ambient light, and therefore may vary during daytime and nighttime image capture, as well as during various weather conditions. Various color and contrast adjustments can be performed using image processing component 34, for example. For example, gamma correction can be used to enhance the brightness of an image reproduced on a monitor or display. As another example, contrast stretching can be used to improve the intensity of color variations in an image, thereby enhancing the fine details in a captured image. Other known techniques may be used to enhance an image, such as techniques for reducing image blur and ghosting, and for image sharpening, for example.

Embodiments can be deployed in numerous settings, such as, for example, ingress and egress lanes, inside complexes and large facilities, border crossings, secure parking facilities. Demonstrative parameters for one embodiment are as follows:

Camera Type: GigE Machine Vision camera—Monochrome
Sensor: CMOS Image Sensor—Optimized to illumination source

### Resolution: 1600×1200 (2 MP)

### Frame Rate: 60 fps

Lens: 25 mm, 2 MP, Low-distortion, Optimized to illumination source
Filter: Matching Illumination wavelength Band Pass

### Protocol: TCP/IP

Illumination Device: LED strobe array—field view—programmable

### Power: 24 VDC LED Array

Dimensions: Including sunshield 400 mm×150 mm×265 mm

### Weight: Camera: 1.2 kg

### Conformity: CE, FCC, RoHS

Enclosure: IP65 rated

### Environmental: −35 C-+60 C

### Window Tint: >35% VLT

### Operations

In installation of the present invention, calibration programming can be provided for calibrating the camera in combination with the illumination device described. By calibrating the camera with the illumination device, the reliability and detail of the captured images are significantly improved. Once the system has been successfully set up, it is ready to record images.

As shown in FIG. 6, an oncoming vehicle 90 to a gateway 92 can be discovered, for example, as it crosses a motion sensor or is detected via a proximity sensor, for example. A set of barrier walls 91 can be placed to channel vehicle traffic into and/or over the entry control point system of the present invention and its components. At such time, a vehicle identifier associated with the vehicle can be discovered, such as by capturing an image of a license plate, detecting an RFID tag, an optically scanned barcode label or other electronically detectable tag, for example. One or more stoplights 95 can be provided to manage the speed of the oncoming vehicle, and the determination process for whether to allow the vehicle to proceed past the barrier (e.g., one-way spikes 97) can proceed as described elsewhere herein. For instance, upon detecting the vehicle, the system can operate such that the camera 152 of device 15 captures an image in synchronization with illumination device 153, such that the captured image depicts the individual(s) within the vehicle with sufficient clarity. The illumination device effectively lights up the vehicle interior, even after the lighting effect travels through a tinted window, to provide highly effective lighting to support effective image capture via the camera. The employment of the camera, illumination device and image processing produces high quality images in all lighting and weather conditions. Further, the image capture does not interfere with or otherwise impair the driver's ability to safely operate the vehicle. The system can identify the number of occupants, and individual occupants can be identified manually or automatically.

The system can then retrieve any available archived images of individuals associated with the vehicle based on the vehicle identifier to determine if the currently captured image depicts the same individual(s) as is/are depicted in any archive images. If, for example, the individual is identified as requiring a denial of entry at point A or point B as shown in FIG. 6, then the vehicle 90 can be directed to exit the entry control point as at C, without gaining entry to the facility. In various embodiments, lights 95 can be controlled by a user operating a user interface 50, 80 and/or 110 as shown in FIGS. 3 through 5, such as through icon 70 in interface 50, for example. In the embodiment represented by the user interface 50 of FIG. 3, the currently captured image 56 of the vehicle occupant is compared with an historical image 58. In the embodiment represented by the user interface 80 of FIG. 4, there may be no historical reference image associated with the vehicle or occupant captured, and thus the currently captured image 75 becomes the historical image 77 for archiving. If the vehicle occupant or occupants are considered worthy of access to the facility through the entry point, the vehicle can be approved to move through points D and E.

Embodiments of the system can also being used to initiate collection and storage of reference images in the database for a given vehicle and occupant(s). In various such embodiments, the system stores information regarding the vehicle's make, model, year and transmission type (e.g., standard (i.e., manual) or automatic), one or more vehicle identifiers, and one or more occupant photographs taken by the camera(s). It will be appreciated that the camera and illumination devices of the present invention allow the system of the present invention to collect and store high resolution images of vehicle occupants. Prior to the storing of collected reference images, the system of the present invention contains programming, such as image processing component 34, which allows a user monitoring the data collection to appropriately trim, crop or otherwise edit and manipulate images.

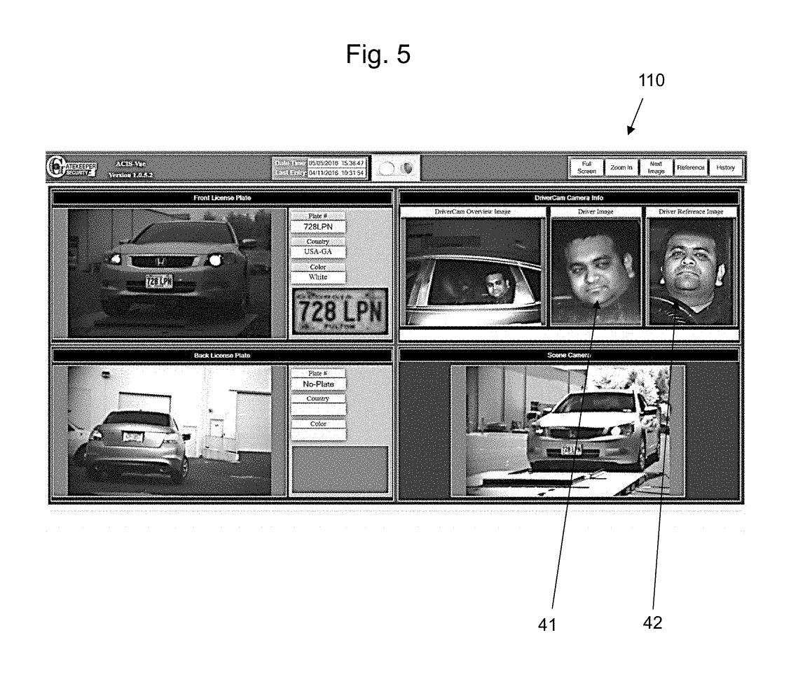

It will be appreciated that aspects of the present disclosure invoke multiple security technologies operating as a group to detect, identify, verify, search and authenticate vehicles and occupants entering a secure facility or crossing a secure boundary. In various embodiments, as a vehicle is detected, an undercarriage image of the vehicle can be captured according to the vehicle inspection systems referenced above. Currently captured undercarriage images can be compared by system 20, 154 or 28 with one or more archived images stored in database 37 or 40, any differences between the images can be noted, and a notice can be issued via administrative/communications component 36 to appropriate personnel for action. For instance, the notice can be a visual and/or audible alarm, which can be invoked at the entry control point (e.g., point A in FIG. 6) or at a separate location via external device 23 in FIG. 1. The currently captured undercarriage image can also be archived in the database. With regard to the captured image(s) of the vehicle occupant, such image(s) can be compared with one or more archived images using component 36, and appropriate personnel can assess through manual analysis as to how well the compared images represent the same person. For instance, in FIG. 5, personnel can assess whether captured image 41 is a close match to archived image 42. Alternatively, or in coordination with the manual assessment, the system can employ facial recognition software to analyze and display results of an automatic comparison of the present image and the archived image. Further, appropriate personnel can be notified via component 36 of a confidence calculation generated by the facial recognition software or component 36 upon the present and archived images being compared. Appropriate notifications and/or alarms as noted above can then be issued depending upon the results and their interpretation.

It will be appreciated that the database of the present invention can be of significant size to support the largest possible operations. A given vehicle's history can also be available for retrieval on demand, including profile information, image information and traffic history. In one embodiment of the present invention, an operator can place a vehicle or an individual on a watch list, such that when that vehicle or individual is detected, an alert is signaled and appropriately communicated.

An operator using the interface described above can thus verify whether an occupant and their vehicle are authorized to enter a facility, inspect the inside of a vehicle in much greater detail, verify the make and model of a vehicle against an authorized vehicle description, communicate with the driver/passenger via a hands free communication device, and control the various other devices such as the auto spikes 97, traffic lights 95, and communications to other sources 23, for example. Additionally, the operator can automatically record all vehicle and driver/passenger activity, place vehicles, drivers and passengers on watch lists and set up monitoring reports and alerts. In this way, embodiments of the present invention can be employed with vehicle access control, vehicle movement monitoring, border crossings and secure parking facilities, among other things. All data/images are entered into a database that allows all types of database analysis techniques to be employed to study historical patterns of entrants or even traffic loads for staffing of security personnel.

In various embodiments, facial recognition programming is provided as part of the image processing component 34 so as to facilitate the identification of individual occupants and/or the comparison of newly captured images with previously captured images. In various embodiments, facial recognition programming can comprise open source software for face detection such as OpenCV™ and commercial software products for facial recognition, such as VeriLook™ by Neurotechnology of Vilnius, Lithuania, FaceVACS™ by Cognitec of Dresden, Germany, and NeoFace™ by NEC Australia Pty Ltd. of Docklands, Victoria, Australia.

The terminology used herein is for the purpose of describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another do not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it should be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

It will be apparent to one skilled in the art that any computer system that includes suitable programming means for operating in accordance with the disclosed methods also falls well within the scope of the present disclosure. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, with programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example. Appropriate hardware, software and programming for carrying out computer instructions between the different elements and components of the present invention are provided.

The present disclosure describes embodiments of the present approach, and these embodiments are presented for illustrative purposes only. These embodiments are described in sufficient detail to enable those skilled in the art to practice the present approach, and it will be appreciated that other embodiments may be employed and that structural, logical, software, electrical and other changes may be made without departing from the scope or spirit of the present invention. Accordingly, those skilled in the art will recognize that the present approach may be practiced with various modifications and alterations. Although particular features of the present approach can be described with reference to one or more particular embodiments that form a part of the present disclosure, and in which are shown, by way of illustration, specific embodiments of the present approach, it will be appreciated that such features are not limited to usage in the one or more particular embodiments or figures with reference to which they are described. The present disclosure is thus neither a literal description of all embodiments nor a listing of features that must be present in all embodiments.

The present approach may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A method for controlling entry of vehicles, comprising the steps of:
providing an entry control device having a camera and an illumination device;
detecting the presence of an oncoming vehicle;
detecting a vehicle identifier associated with the oncoming vehicle;
capturing, via the camera, at least one present image of at least one individual present within the vehicle through a window of the vehicle;
obtaining at least one archived image of at least one individual previously associated with the detected vehicle identifier; and
comparing the at least one present image with the at least one archived image.

2. The method of claim 1, wherein detecting the vehicle identifier includes reading a license plate of the oncoming vehicle.

3. The method of claim 1, wherein detecting the vehicle identifier includes detecting one of: an RFID signal associated with the oncoming vehicle, and an optically scanned barcode label.

4. The method of claim 1, wherein the step of comparing the at least one present image with the at least one archived image is performed using facial recognition programming.

5. The method of claim 1, wherein the step of comparing the at least one present image with the at least one archived image includes determining whether the at least one individual in the at least one present image is the same individual as the at least one individual from the at least one archived image.

6. The method of claim 1, further including the step of activating the illumination device when capturing the at least one present image.

7. The method of claim 6, wherein the steps of activating the illumination device and capturing the at least one present image via the camera are sequenced according to an image processing protocol.

8. The method of claim 7, wherein the image processing protocol specifies the relative timing of activating the illumination device and capturing the at least one present image.

9. The method of claim 7, wherein the image processing protocol specifies that the camera be configured to receive light in the same or similar wavelength as the auxiliary illumination device and the auxiliary illumination device be configured to emit light in the same or similar wavelengths as the camera receives the light

10. A method for establishing records for use in identifying individual occupants in a vehicle, comprising the steps of:
recording one or more images of individual occupants of at least one vehicle, wherein the one or more images are taken through a window of the at least one vehicle;
associating the recorded one or more images with at least one vehicle identifier pertaining to the at least one vehicle; and
storing the one or more images in a computer database.

11. The method of claim 10, wherein the step of recording one or more images includes illuminating at least a portion of the at least one vehicle using an illumination device, and capturing the at least one image using a camera synchronized with the illumination device.

12. The method of claim 10, including the step of categorizing the one or more images according to the vehicle year, make, model or vehicle identifier.

13. The method of claim 12, wherein the vehicle identifier is at least one of: a license number, a readable tag.

14. A method for vehicle access control, comprising the steps of:
providing a camera having a lens facing a field of view;
providing an illumination device for illuminating the field of view;
providing an image processing component for synchronizing the activation of the illumination device with activation of the camera so as to record, by the camera, at least one image of a vehicle occupant through a window of a vehicle.

15. The method of claim 14, including the steps of:
detecting a vehicle identifier associated with the vehicle;
obtaining at least one archived image of at least one individual previously associated with the detected vehicle identifier; and
comparing the at least one present image with the at least one archived image.

16. The method of claim 15, wherein detecting the vehicle identifier includes reading a license plate of the oncoming vehicle.

17. The method of claim 15, wherein detecting the vehicle identifier includes detecting one of: an RFID signal associated with the oncoming vehicle, and an optically scanned barcode label.

18. The method of claim 15, wherein the step of comparing the at least one present image with the at least one archived image is performed using facial recognition programming.

19. The method of claim 15, wherein the step of comparing the at least one present image with the at least one archived image indicates whether the at least one individual in the at least one present image is the same individual as the at least one individual from the at least one archived image.

20. An entry control system, comprising:
a camera having a lens facing a field of view;
an illumination device for illuminating the field of view;
at least one data storage device operable to store one or more images of at least one vehicle occupant and at least one vehicle identifier;
at least one computer processor operable to execute computer-readable instructions to associate the one or more images of at least one vehicle occupant with at least one vehicle identifier, and to retrieve the one or more images upon detection of a vehicle in the field of view of the camera, wherein the detected vehicle has a present vehicle identifier matching at least one vehicle identifier stored in the at least one data storage device.

21. The system of claim 20, wherein the camera is operable to capture at least one present image of a vehicle occupant in the detected vehicle, and wherein the at least one processor is further operable to execute computer-readable instructions to compare the at least one present image with the retrieved one or more images.

22. The system of claim 20, wherein the at least one vehicle identifier is a license plate number.

23. The system of claim 20, wherein the at least one vehicle identifier is a readable tag.

24. The system of claim 21, wherein the computer-readable instructions to compare the at least one present image with the retrieved one or more images includes facial recognition programming.

25. The system of claim 21, wherein the at least one processor is further operable to execute computer-readable instructions to determine whether the vehicle occupant in the at least one present image is the same individual as the at least one occupant from the one or more retrieved images.

26. The system of claim 20, wherein the at least one processor is operable to execute computer-readable instructions to activate the illumination device and capture the at least one present image via the camera in a sequenced manner according to an image processing protocol.

27. The system of claim 26, wherein the image processing protocol specifies the relative timing of activating the illumination device and capturing the at least one present image.

28. The system of claim 26, wherein the image processing protocol specifies that the camera and auxiliary illumination device be configured to emit light in the same or similar wavelengths.

29. The system of claim 20, wherein the at least one computer processor is operable to identify, verify, search and authenticate vehicles and occupants crossing a controlled barrier, including:
detecting the presence of an oncoming vehicle;
detecting a vehicle identifier associated with the oncoming vehicle;
capturing an undercarriage image of the vehicle;
comparing the at least one present undercarriage image with at least one archived image;
identifying any differences between the compared under vehicle images;
archiving the at least one present undercarriage image in a database for future use;
capturing, via the camera, at least one present occupant image of at least one individual present within the vehicle through a window of the vehicle;
obtaining at least one archived occupant image of at least one individual previously associated with the detected vehicle identifier;
comparing the at least one present occupant image with the at least one archived occupant image;
presenting the present occupant image and the archived occupant image on a display; and
presenting the results of an automatic comparison of the present occupant image and the archived occupant image using facial recognition software.
